(19) United States
(12) Patent Application Publication
(10) Pub. No.: US 2018/0002954 A1
(43) Pub. Date: Jan. 4, 2018

(54) VEHICULAR DOOR HANDLE APPARATUS

(71) Applicant: ALPHA CORPORATION, Yokohama-shi (JP)

(72) Inventors: Isamu UEMURA, Yokohama-shi (JP); Takashi ONO, Yokohama-shi (JP); Makoto IGETA, Yokohama-shi (JP); Masaya ONODA, Yokohama-shi (JP)

(73) Assignee: ALPHA CORPORATION, Yokohama-shi (JP)

(21) Appl. No.: 15/704,481

(22) Filed: Sep. 14, 2017

Related U.S. Application Data
(63) Continuation of application No. PCT/JP2016/058301, filed on Mar. 16, 2016.

(30) Foreign Application Priority Data
Mar. 16, 2015 (JP) 2015-051886

(51) Int. Cl. E05B 77/06; E05B 85/16

(52) U.S. Cl. CPC E05B 77/06; E05B 85/16

(57) ABSTRACT

A vehicular door handle apparatus includes a fixed handle fixed to a door of a vehicle from a front surface of the door, a movable handle rotatably connected to the fixed handle, and an output lever rotatably connected to a connecting block projected on the fixed handle and inserted into an inside of the door. An operational force on the movable handle is transmitted to a door lock device fixed to the door through the output lever. A counter weight which cancels a force in an actuation direction occurred in the output lever by inertia when the door receives a side collision force, is connected to the connecting block.

### CROSS REFERENCE TO RELATED APPLICATIONS

This application is a continuation of PCT application No. PCT/JP2016/058301, which was filed on Mar. 16, 2016 based on Japanese Patent Application (No. 2015-051886) filed on Mar. 16, 2015, the contents of which are incorporated herein by reference.

### TECHNICAL FIELD

The present disclosure relates to a vehicular door handle apparatus.

### BACKGROUND ART

A known handle apparatus constructed by coupling a movable handle to a fixed handle fixed to a door of a vehicle is a handle apparatus described in Patent Reference 1 (JP-Y2-6-10041).

Patent Reference 1 discloses a handle apparatus in which a movable handle is fitted into a fixed handle formed in a U-shaped cross section and is projected from a fitting part and a rotational operation is performed so as to push a part projected from the fitting part into the fitting part to thereby perform an operation of release from a door lock device.

However, the handle apparatus disclosed by Patent Reference 1 has a problem in which an operable range of the movable handle is small due to short dimensions of the movable handle and operability is bad.

This problem can be solved by increasing the length of the movable handle to the extent of the whole length of a handhold part of the handle, but such a configuration has a problem of increasing an inertial force produced in the movable handle in the case of applying a side collision force to a vehicle and increasing the risk of carelessly opening the door at the time of a side collision.

### PRIOR ART REFERENCE

### Patent Reference

[Patent Reference 1] JP-Y2-6-10041

### DISCLOSURE OF THE INVENTION

The present disclosure relates to a vehicular door handle apparatus with good operability and high safety.

According to the present disclosure, a vehicular door handle apparatus includes a fixed handle 2 fixed to a door 1 of a vehicle from a front of the door 1, a movable handle 3 connected to the fixed handle 2 so as to be rotatably operable, and an output lever 5 rotatably connected to a connecting block 4 projected on the fixed handle 2 and inserted into an inside of the door 1.

An operational force on the movable handle 3 is transmitted to a door lock device 6 fixed to the door 1 through the output lever 5.

A counter weight 7 which cancels a force in an actuation direction occurred in the output lever 5 by inertia when the door 1 receives a side collision force, is connected to the connecting block 4.

In the present disclosure, the vehicular door handle apparatus includes the counter weight 7 for eliminating the operational force in the unlocking direction produced in the output lever 5 at the time of the side surface collision and thereby, the risk of carelessly opening the door by an inertial force produced in the movable handle can be eliminated to improve operability.

Also, since the counter weight 7 is connected to the fixed handle 2, in the case of work of attachment of the handle apparatus to the vehicle, the need to separately fix a holding body of the counter weight 7 is eliminated, with the result that workability of attachment to the vehicle can be improved.

According to the present disclosure, in the vehicular door handle apparatus, the counter weight 7 may be configured to be biased in a direction of pressure contact with the output lever 5 and is rotationally driven so as to follow rotation of the output lever 5 in the actuation direction and also the counter weight 7 may freely idle in a release direction of contact with the output lever 5.

In the present disclosure, since the counter weight 7 can run idle in the release direction of contact with the output lever 5, an operational force transmission system ranging from the movable handle 3 to the output lever 5 is irreversible and power transmission from the side of the output lever 5 to the movable handle 3 is not permitted and in the case of applying a side collision force in the opposite direction, only the counter weight 7 runs idle and power transmission to the output lever 5 is not performed, with the result that the door 1 can surely be prevented from being carelessly opened.

Also, according to the present disclosure, in the vehicular door handle apparatus, the counter weight 7 may be arranged inside an orthogonal projection area to a projection surface including a rotational axis of the fixed handle 2 to the door 1 in an initial rotational position.

In the present disclosure, the vehicular handle apparatus is mounted from the outside of the door 1 by inserting the output lever 5 etc. into the door 1 from a mounting opening 1a opened in a door panel. The counter weight 7 is arranged in the orthogonal projection surface of the fixed handle 2 to the front of the door 1 and thereby, workability of attachment of the handle apparatus can be improved by increasing the panel passage capability of passing the counter weight 7 through the mounting opening 1a and inserting the counter weight 7 into the door 1.

Further, according to the present disclosure, in the vehicular door handle apparatus, the counter weight 7 may be rotatable around a rotational axis parallel to the rotational axis of the movable handle 3 and a part of the counter weight 7 is stored inside a protrusion part of the fixed handle 2 to an outside of the panel in the initial rotational position.

In the present disclosure, a part of the counterweight 7 is stored inside the fixed handle 2 and thereby, the panel passage capability can be increased since the protrusion part from the fixed handle 2 is decreased at the time of work of attachment to the door 1. Further, the counter weight 7 is moved in a vehicle width direction and thereby, a movement distance in an orthogonal projection direction can be made shorter than the case of moving the counter weight 7 along the panel front, with the result that the mounting opening 1a can be decreased.

Also, according to the present disclosure, in the vehicular door handle apparatus, the output lever 5 may have an output piece 9 extended in a rod shape toward the inside of the door 1, and an input piece 8 abutting on the movable handle 3 and extended along a surface of the door 1 in an outside of the door 1 in a state of attachment to the door 1 and the output lever 5 may be pivoted concentrically with a rotational axis of the counter weight 7.

In the present disclosure, the input piece 8 of the output lever 5 is arranged along the front of the door 1 in the outside of the door 1, and the need for insertion into the mounting opening 1a is eliminated, and the output piece 9 is extended in the rod shape toward the inside of the door 1 and thereby, the insertion into the mounting opening 1a can be facilitated to thereby improve workability of attachment to the door 1.

Further, even when the input and output piece 9 is formed long, the panel passage capability is not decreased, with the result that the operational force on the movable handle 3 can be transmitted at a sufficient lever ratio to improve operability.

Also, according to the present disclosure, the vehicular door handle apparatus may further includes a bell crank 10 which is rotatably connected to the connecting block 4 of the fixed handle 2 and which is connected to the door lock device 6. The bell crank 10 may be rotatably coupled around an axis orthogonal to a rotational axis of the output lever 5.

According to the present disclosure, by canceling the inertial force at the time of the side surface collision, the door can be prevented from being carelessly opened at the time of the collision, and the movable handle with a sufficient length can be obtained, and safety and operability can be improved.

### BRIEF DESCRIPTION OF THE DRAWINGS

FIG. 1 is a front view of a handle apparatus.

FIG. 2 is a back view of the handle apparatus.

FIG. 3 is an enlarged view of part 3A of FIG. 2.

FIG. 4 is a view seen from a direction of arrow 4A of FIG. 2.

FIG. 5 is a sectional view taken on line 5A-5A of FIG. 1.

FIG. 6 is a sectional view taken on line 5A-5A of FIG. 1 in an actuation state.

FIG. 7 is an exploded view of the handle apparatus.

FIG. 8 is a view showing a counter weight and an output lever.

FIG. 9 is a sectional view taken on line 9A-9A of FIG. 8.

FIG. 10 is a sectional view taken on line 10A-10A of FIG. 8 after coupling.

FIG. 11 is a sectional view taken on line 10A-10A of FIG. 8 showing a relation between the counterweight and the output lever in an actuation state.

FIG. 12 is a view showing a state in which the counter weight runs idle.

### MODE FOR CARRYING OUT THE INVENTION

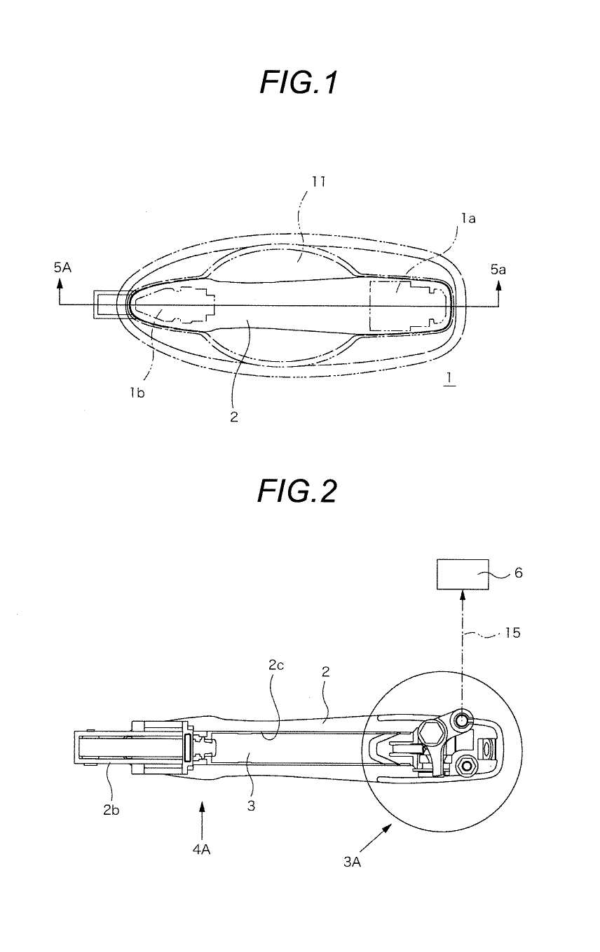

As shown in FIGS. 1 to 12, a door handle apparatus is formed by coupling a movable handle 3 to a fixed handle 2, and is fixed to a door 1 by fixing the fixed handle 2 from the front of a panel of the door 1 in a posture in which the left side faces to the forward side of a vehicle in FIG. 1 (hereinafter, in the present description, with reference to a posture of attachment to the vehicle, “upward and downward” and “forward and backward” directions are set, and a downward direction in FIG. 4 is set in the “front side” and the side opposite to the downward direction is set in the “back side”).

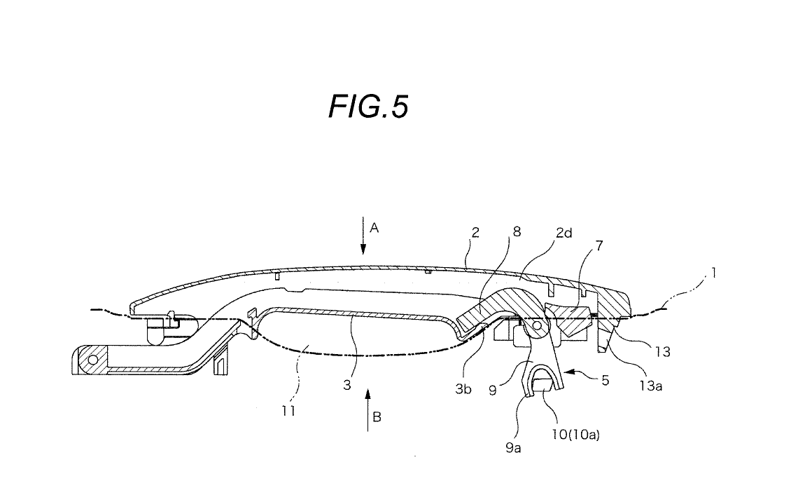

Also, as shown in FIGS. 1 and 5, the door panel (door 1) is formed with a recess 11 for providing space for inserting a hand in a gap with the front of the door panel 1 in the case of an opening operation of the door 1 and further, backward and forward insertion openings 1a, 1b for fixing the fixed handle 2 are opened.

As shown in FIG. 4, the fixed handle 2 has panel attachment surfaces 12 on forward and backward ends, and the center of the fixed handle 2 is provided with a handhold corresponding part 2a bulged from the front of the door panel 1 so as to correspond to the recess 11 of the door panel 1.

This fixed handle 2 is fixed to the door 1 by inserting a fixing block 13 formed on the backward end into the door 1 from the backward opening 1a and then screwing the fixing block 13 on the door panel 1 and also mounting a proper clip member to the forward end inserted into the door 1 from the forward opening 1b. The fixing block 13 is provided with a screw insertion hole 13a used for screwing on the door panel 1 (see FIG. 5).

One end of the movable handle 3 is rotatably pivoted on a hinge protrusion piece 2b which is projected from the forward end of the fixed handle 2 and enters the inside of the door 1 in a state fixed to the door 1, and the movable handle 3 is held in an initial rotational position shown in FIG. 5.

Also, the fixed handle 2 is longitudinally formed with a fitting groove 2c for storing the movable handle 3 (see FIG. 2) and further, the movable handle 3 and the fixed handle 2 are respectively provided with stoppers (not shown) for regulating clockwise rotation of the movable handle 3 in excess of the initial rotational position in FIG. 5.

This movable handle 3 has the length ranging from the end of coupling to the fixed handle 2 to the backward end of the fixed handle 2 in excess of the handhold corresponding part 2a, and an intermediate part of the movable handle 3 is formed with a handhold part 3a corresponding to the handhold corresponding part 2a of the fixed handle 2.

As shown in FIG. 4, the handhold part 3a is overhung from the handhold corresponding part 2a of the fixed handle 2 to the back side when the movable handle 3 is in the initial rotational position, and a margin of operation to the front side is provided.

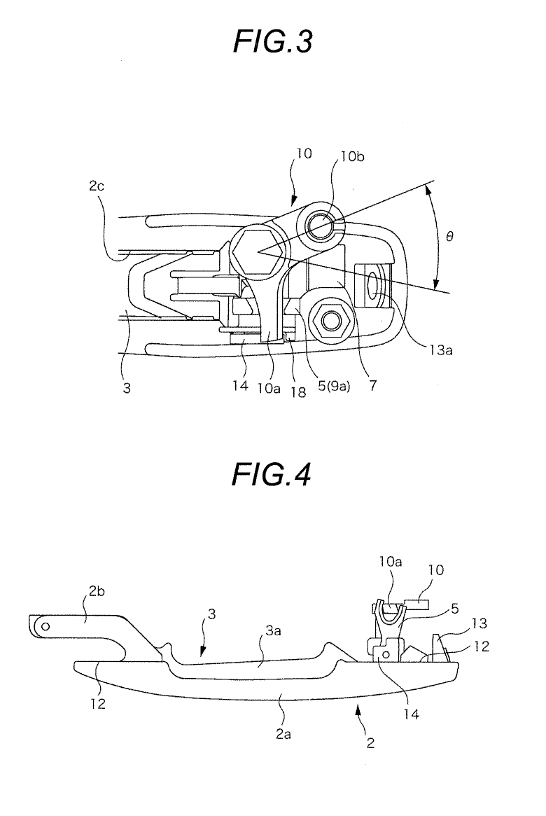

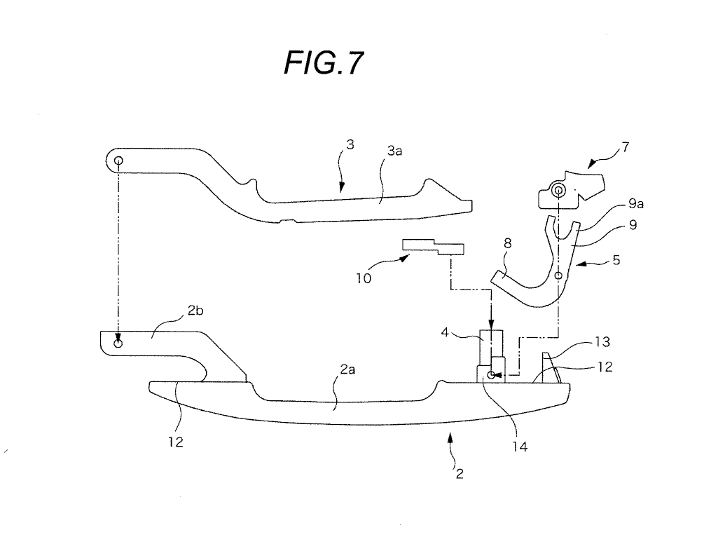

Also, as shown in FIGS. 3 and 7, in the backward end of the fixed handle 2, a connecting block 4 and a pin receiving piece 14 are projected in a back direction. The connecting block 4 and the pin receiving piece 14 have depth dimensions entering the inside of the door 1 with the fixed handle 2 attached to the panel, and an output lever 5 and a counter weight 7 are coupled concentrically around a rotational axis which is installed between the connecting block 4 and the pin receiving piece 14 and is arranged in upward and downward directions.

The output lever 5 has an output piece 9 which includes a fork-shaped coupled part 9a on the top and is overhung to the back side, and an input piece 8 overhung toward the forward side of the backward part once extended from the other end of the output piece 9 to the front side, and is formed in an L shape, and the output lever 5 is pivoted at the boundary between the input piece 8 and the output piece 9.

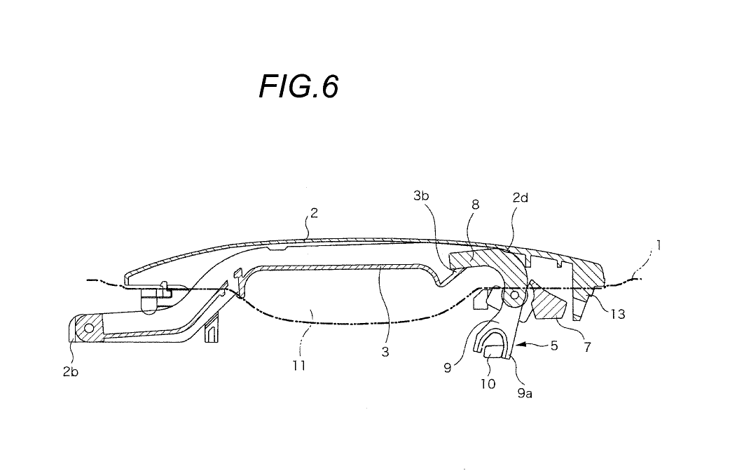

As shown in FIG. 5, the top of the input piece 8 of the output lever 5 corresponds to a pressing movement protrusion part 3b projected from the backward end of the movable handle 3 to the front side in a mounting state, and the output lever 5 is rotated between an initial rotational position determined by the initial rotational position of the movable handle 3 and an actuation rotational position in which a bent part of the input piece 8 shown in FIG. 6 abuts on a lever stopper part 2d formed on the fixed handle 2.

Further, the connecting block 4 is formed in a depth dimension entering a deeper part of the door 1 than the pin receiving piece 14, and a bell crank 10 is connected to the top of the connecting block 4 rotatably around an axis orthogonal to rotational axis of the output lever 5 and the counter weight 7.

As shown in FIG. 3, the bell crank 10 has a lever-shaped coupling part 10a in one end, and a coupling hole 10b for coupling an inner wire of a cable device 15 on the other end, and is formed in a doglegged shape, and the bell crank 10 is pivoted on a bent part with the lever-shaped coupling part 10a pinched by the coupled part 9a of the output lever 5.

Consequently, in this embodiment, when the movable handle 3 is rotated from the initial rotational position shown in FIG. 5 to the actuation rotational position shown in FIG. 6, the output lever 5 is rotated by an angle (0) from the initial rotational position and is moved to the actuation rotational position (see FIG. 3). With this rotation, the bell crank 10 is driven to the initial rotational position, and a door lock device 6 is actuated through the cable device 15 connected to the bell crank 10 (see FIG. 2).

Also, an biasing force in a direction of the initial rotational position is applied to the bell crank 10 by a torsion spring (not shown), and the output lever 5 and the movable handle 3 are held in the initial rotational position in a non-operation state of the movable handle 3.

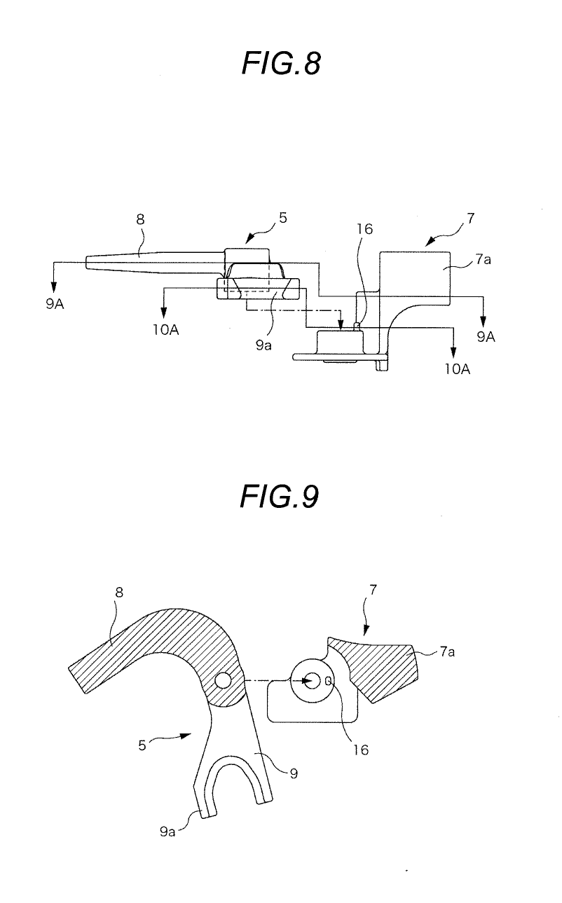

On the other hand, as shown in FIGS. 8 and 9, the counter weight 7 is formed of a metal material such as die-cast zinc so as to generate a predetermined weight, and a weight part 7a with a large capacity is arranged on the backward side with respect to the rotational center to shift the center of gravity to the backward side. A position of the center of gravity and a weight of this counter weight 7 are set so as to cancel a driving force in a direction of the actuation rotational position produced in the output lever 5 by inertia in the case of applying a side collision force in a direction of arrow A in FIG. 5.

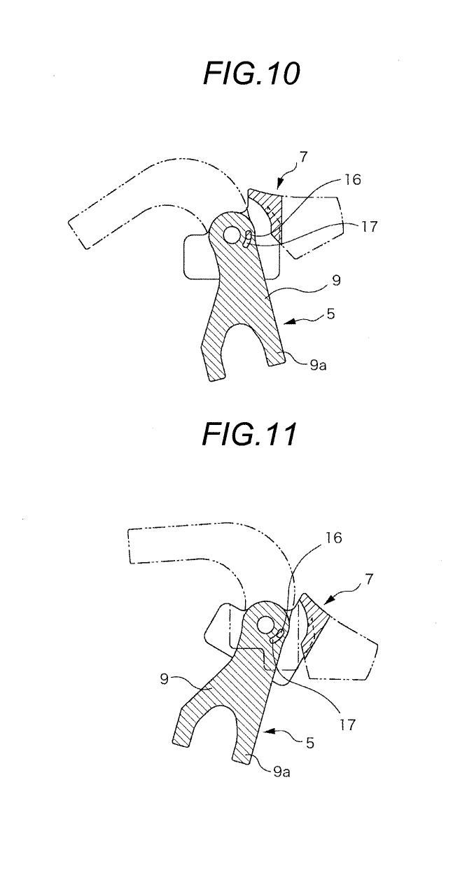

Also, as shown in FIG. 8, the counter weight 7 is pivoted so that the rotational center part has a lamination relation with the output lever 5, and a stopper boss 16 is projected on a slide boundary surface to the output lever 5. This stopper boss 16 is movably fitted into an arc recess 17 formed in a slide boundary surface of the output lever 5 (see FIG. 10).

An biasing force in a counterclockwise direction in FIG. 10 is applied to the counter weight 7 by a torsion spring (not shown), and the stopper boss 16 abuts on an end wall of the arc recess 17. As shown in FIG. 11, in this state, the counter weight 7 follows rotation to the side of the actuation rotational position of the output lever 5.

Also, the arc recess 17 of the output lever 5 is extended in a clockwise direction in FIG. 10, and idling of the counter weight 7 in the clockwise direction is permitted.

Consequently, in the present example, when the side collision force in the direction of arrow A is applied in an initial state shown in FIG. 5 and inertia in the actuation rotational direction acts on the movable handle 3 and the output lever 5 is rotated in the actuation rotational direction, a rotational force in the counterclockwise direction is produced in the counterweight by inertia, and actuation of the output lever 5 is regulated to prevent unlocking of the door lock device 6.

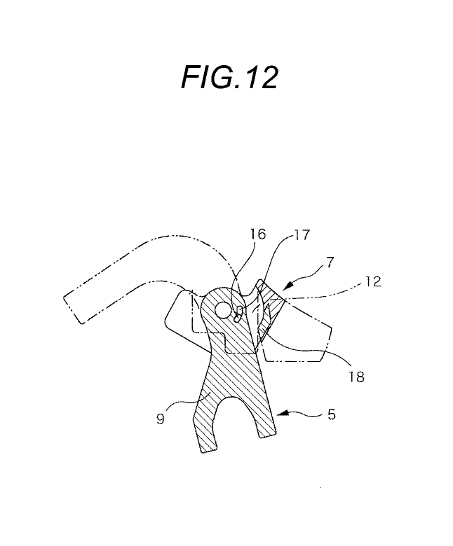

Further, when the side collision force in a direction of arrow B in FIG. 5 is applied, only the counter weight 7 is rotated in the clockwise direction and the output lever 5 is not rotated, with the result that unlocking of the door lock device 6 is prevented. In order to avoid interference with the output lever 5 in the case of singly rotating the counter weight 7, the counter weight 7 is provided with a stroke stopper 18 for regulating a stroke end in the clockwise direction by abutting on the pin receiving piece 14 as shown in FIG. 12 (see FIG. 3).

The present application is based on Japanese patent application (patent application No. 2015-051886) filed on Mar. 16, 2015, and the contents of the patent application are hereby incorporated by reference.

### DESCRIPTION OF REFERENCE NUMERALS AND SIGNS

1 DOOR
2 FIXED HANDLE
3 MOVABLE HANDLE
4 CONNECTING BLOCK
5 OUTPUT LEVER
6 DOOR LOCK DEVICE
7 COUNTER WEIGHT
8 INPUT PIECE
9 OUTPUT PIECE
10 BELL CRANK

1. A vehicular door handle apparatus comprising:
a fixed handle fixed to a door of a vehicle from a front surface of the door;
a movable handle connected to the fixed handle so as to be rotatably operable; and
an output lever rotatably connected to a connecting block projected on the fixed handle and inserted into an inside of the door,
wherein an operational force on the movable handle is transmitted to a door lock device fixed to the door through the output lever, and
wherein a counter weight which cancels a force in an actuation direction occurred in the output lever by inertia when the door receives a side collision force, is connected to the connecting block.

2. The vehicular door handle apparatus according to claim 1,
wherein the counter weight is configured to be biased in a direction of pressure contact with the output lever and be rotationally driven so as to follow a rotation of the output lever in the actuation direction, and
wherein the counter weight freely idle in a release direction of contact with the output lever.

3. The vehicular door handle apparatus according to claim 1,
wherein the counter weight is arranged inside an orthogonal projection area to a projection surface including a rotational axis of the fixed handle to the door in an initial rotational position.

4. The vehicular door handle apparatus according to claim 1,
wherein the counter weight is rotatable around a rotational axis of the counterweight parallel to a rotational axis of the movable handle, and
wherein a part of the counter weight is stored inside a protrusion part of the fixed handle to an outside of a panel in the initial rotational position.

5. The vehicular door handle apparatus according to claim 4,
wherein the output lever has an input piece abutting on the movable handle and extended along a door surface in an outside of the door in a state of attachment to the door, and an output piece extended in a rod shape toward the inside of the door, and
wherein the output lever is pivoted concentrically with a rotational axis of the counter weight.

6. The vehicular door handle apparatus according to claim 1, further comprising:
a bell crank which is rotatably connected to the connecting block of the fixed handle and which is connected to the door lock device,
wherein the bell crank is rotatably coupled around an axis orthogonal to a rotational axis of the output lever.
